(19) United States
(12) Patent Application Publication
(10) Pub. No.: US 2021/0158458 A1
(43) Pub. Date: May 27, 2021

(54) PERSPECTIVE-BASED SYNCHRONIZATION FOR ONLINE COLLABORATIONS

(71) Applicant: INTERNATIONAL BUSINESS MACHINES CORPORATION, Armonk, NY (US)

(72) Inventors: Emily Regina Waldrop, Columbus, OH (US); Jaime Mae Stockton, Groton, MA (US); Paul R. Bastide, Ashland, MA (US); GINA RANALLI, Columbus, OH (US)

(21) Appl. No.: 16/693,812

(22) Filed: Nov. 25, 2019

(51) Int. Cl. G06Q 50/00; G06Q 10/10; G06F 40/166; H04L 29/08; H04L 29/06

(52) U.S. Cl. CPC G06Q 50/01; G06Q 10/105; H04L 65/403; G06F 40/166; H04L 67/22; G06Q 10/107

(57) ABSTRACT

A method, computer system, and computer program product for generating a personalized summary of missed content from across multiple collaboration platforms are provided. The embodiment may include monitoring user participation with respect to a plurality of conversations across a plurality of collaboration platforms. The embodiment may also include determining content the user missed from the plurality of conversations based on the user participation. The embodiment may further include summarizing the missed content from each of the plurality of collaboration platforms. The embodiment may also include presenting the summarized missed content to the user in a current conversation.

### BACKGROUND

The present invention relates, generally, to the field of computing, and more particularly to online collaboration systems.

Online collaboration systems are useful tools to create strategies, policies, and structures in order to better organize data, work products, and practices that may promote cooperation among different parties or individuals within an organization, such that organizational goals may be achieved much faster and effectively. The concept of online collaboration systems may relate to the idea of virtual workspaces and e-work, which extends the traditional concept of professionals to include any type of knowledge worker who intensively uses the information and communications technology environments and tools in their working practices. A group collaboration technology may include hardware and software tools that help groups to access and share the information the individuals need to meet, train or teach.

### SUMMARY

According to one embodiment, a method, computer system, and computer program product for generating a personalized summary of missed content from across multiple collaboration platforms are provided. The embodiment may include monitoring user participation with respect to a plurality of conversations across a plurality of collaboration platforms. The embodiment may also include determining content the user missed from the plurality of conversations based on the user participation. The embodiment may further include summarizing the missed content from each of the plurality of collaboration platforms. The embodiment may also include presenting the summarized missed content to the user in a current conversation.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a perspective-based online collaboration synchronization process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to online collaboration systems. The following described exemplary embodiments provide a system, method, and program product to monitor the time when a user joins or leaves a conversation and analyze the messages received during a meeting to associate the messages with a user's interested role. Therefore, the present embodiment has the capacity to improve the technical field of online collaboration systems by allowing a user to receive personalized summaries of the messages based on when a user joins a conversation, which may contain only the information related to the user interests and responsibilities.

As previously described, online collaboration systems are useful tools to create strategies, policies, and structures in order to better organize data, work products, and practices that may promote cooperation among different parties or individuals within an organization, such that organizational goals may be achieved much faster and effectively. The concept of online collaboration systems may relate to the idea of virtual workspaces and e-work, which extends the traditional concept of professionals to include any type of knowledge worker who intensively uses the information and communications technology environments and tools in their working practices. A group collaboration technology may include hardware and software tools that help groups to access and share the information the individuals need to meet, train or teach.

Online social networks and collaboration tools are used to connect people and information in logical and organized ways to share and process information between users. The most common mechanisms of sharing and processing information are via inbox, text messages, walls, activity streams, timelines, and profiles. These mechanisms enable people to rapidly share information and reach valuable conclusions. However, with the enormous number of messages being sent and received, it may be challenging for a user to join and keep up with all of the conversations they switch between on a daily basis. For example, User A has many different responsibilities and is a very important member of a team. User A constantly switches from one conversation to another throughout the workday, missing valuable information that is shared in any conversation outside of the User A's current view. Therefore, there is clearly a need to better enable people to quickly understand and keep up with the myriad of conversations they are involved with each day.

According to one embodiment, the present invention may integrate with various social media communication and collaboration services to archive messages into a datastore and classify messages based on conversation IDs and the time of the completion of the messages. In at least one other embodiment, the present invention may also analyze the messages received during a meeting and associate each summarized or analyzed message with a user's interested role. The present invention may further generate a summary of missed conversations for a user.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for generating a summary of conversations based on the analysis of messages communicated when a user joins or leaves a conversation and associating the summary with the user's interested role.

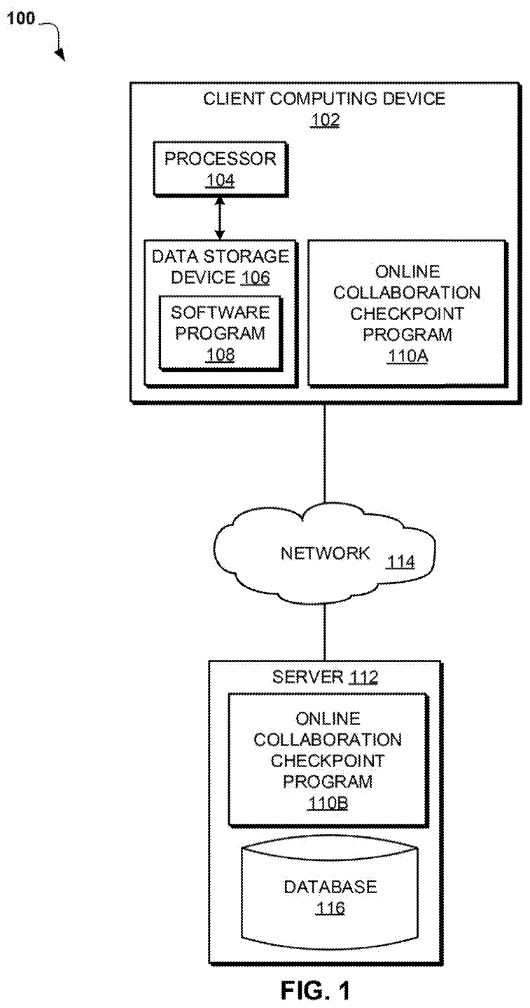

Referring to FIG. 1, an exemplary networked computer environment 100 is depicted according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

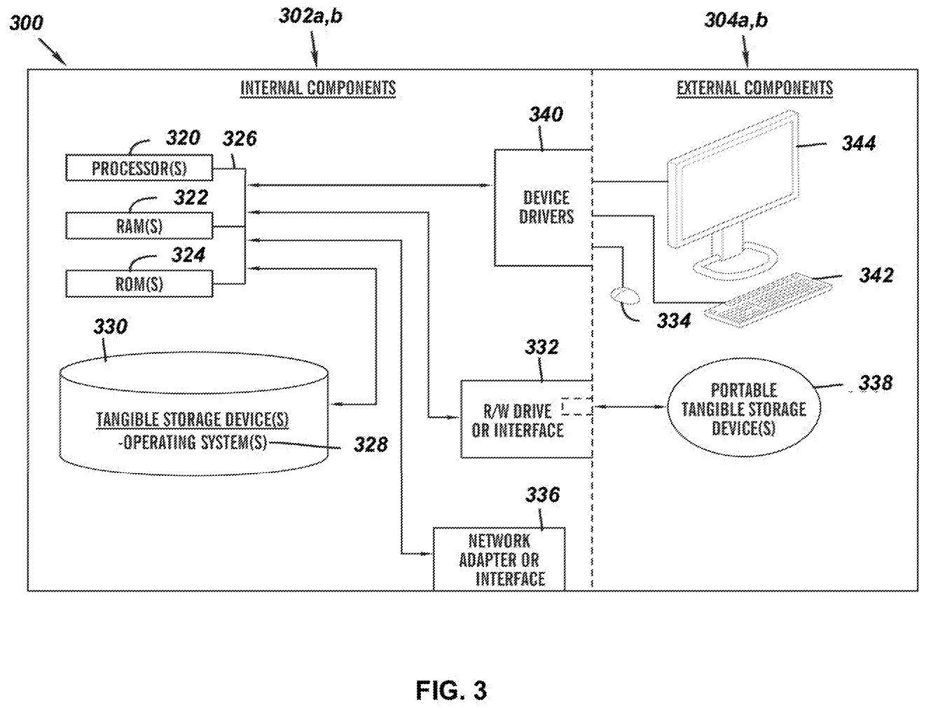

Client computing device 102 may include a processor 104 and a data storage device 106 that is enabled to host and run a software program 108 and an online collaboration checkpoint program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running an online collaboration checkpoint program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

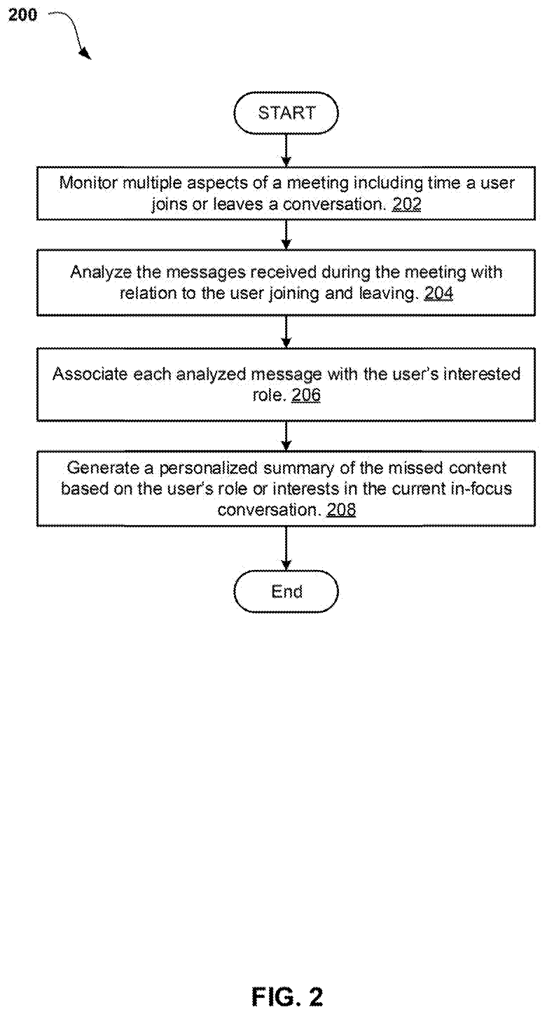

According to the present embodiment, the online collaboration checkpoint program 110A, 110B may be a program capable of monitoring a user's participation with respect to a plurality of conversations across multiple collaboration platforms and determining the content of the messages the user missed from the plurality of the conversations. The online collaboration checkpoint process is explained in further detail below with respect to FIG. 2.

Referring to FIG. 2, an operational flowchart illustrating an online collaboration checkpoint process 200 is depicted according to at least one embodiment. At 202, the online collaboration checkpoint program 110A, 110B monitors multiple aspects of a meeting including the time when a user joins or leaves a conversation. According to one embodiment, the online collaboration checkpoint program 110A, 110B may integrate with various social media communication and collaboration services to archive messages into a datastore and identify the messages based on conversation-IDs and the time of the completion of the messages. In at least one other embodiment, social data may be pulled into secondary storage for analysis using social media aggregation APIs. For example, the data related to the archived messages are loaded into an analytical data store or atomic table using the following schema:

TABLE 1

| Message details | {Body, Subject, Metadata} |
|---|---|
| Topic concepts | [0, Concept-1, Concept-2, . . .] |
| Unique message identifier | Generated or extracted from messages |
| Conversation identifier | Generated through membership lists or |
| | extracted form messages |
| Access control | Membership list of a conversation |
| Owner | Owner or author of a specific message. |
| | If a user is unknown, the message |
| | is marked as Unknown |
| Location | GPS, Longitude, Latitude, Region, etc. |
| Tenant | Assigned company or group used for |
| | sharing data |
| Terminal | Indication of when a message ended. |
| Weights | Views or participation metrics |

In yet another embodiment, the online collaboration checkpoint program 110A, 110B may add other metadata to the above table indicating access control member's reputation, expertise area, author reputation, author expertise area or sentiment. Further, the online collaboration checkpoint program 110A, 110B may populate extracted concepts and categories using natural language processing (NLP). In at least one other embodiment, the online collaboration checkpoint program 110A, 110B may assert a conversation based on a participants list if a conversation identifier is not included in the metadata. The online collaboration checkpoint program 110A, 110B may only consider in-progress messages (versus messages which have concluded). For example, if a user is a member of a conversation regarding “Defect A” and also a member of a conversation “closing Defect A”, the user may not need to know details about “Defect A”.

The online collaboration checkpoint program 110A, 110B may record user join-leave time for each channel in which the user may be participating. The online collaboration checkpoint program 110A, 110B may record the data in a look-up table as illustrated below:

TABLE 2

| Channel | Type | Time | User |
|---|---|---|---|
| #defect-1 | LEAVE | Time-0 | A |
| #squad-a | JOIN | Time-0 | A |
| #defect-1 | JOIN | Time-0 | B |

The online collaboration checkpoint program 110A, 110B may also consider focus-related information as a third type using eye-gaze tracking techniques or based on monitoring of a user's window focus or handle using a mouse. The online collaboration checkpoint program 110A, 110B may further establish a time series dependency between all messages in a conversation channel. For example, a dependent flow may be established based on each message's time sequence or timestamp associated with each message. Simultaneous messages may be separated and ordered by topic and conversation. Messages may be scanned to determine relevancy to a username, responsibility or job role to identify details and references passed between different users. In at least one other embodiment, the online collaboration checkpoint program 110A, 110B may ignore bot messages unless referenced or responded to by a human.

At 204, the online collaboration checkpoint program 110A, 110B analyzes the messages received during a meeting with relation to the time when a user joins or leaves a conversation. According to one embodiment, the online collaboration checkpoint program 110A, 110B may retrieve the last time a user looked at ongoing conversations in a given conversation channel and record each time the user joined or left the conversation channel. The online collaboration checkpoint program 110A, 110B may extract the multiplicity of missed messages since the time the user last saw messages on the same channel. The online collaboration checkpoint program 110A, 110B may also retrieve any ongoing and related thread to the root of the conversation or related to a specific point in time. For example, if a user was participating in a conversation channel related to a topic “Project A—Defect 1”, and the user left the channel at a certain point of time to attend other meetings, the online collaboration checkpoint program 110A, 110B may record the time the user left the channel and monitor any ongoing messages related to a discussion that was taking place until the point of the time the user left the channel. The online collaboration checkpoint program 110A, 110B may further build a summary based on the user's interest. For example, if a user's job role is to manage the entire Project A and to come up with a countermeasure for the above-mentioned Defect 1, the online collaboration checkpoint program 110A, 110B may take into consideration of the user's interest based on the above job role and build a summary which highlights any countermeasure plans that have been discussed by the team members and the deadlines associated with those countermeasures.

At 206, the online collaboration checkpoint program 110A, 110B associates each analyzed message with the user's interested role. According to one embodiment, the online collaboration checkpoint program 110A, 110B may use summaries to generate a useful transcript containing different perspectives of multiple users who may have missed particular conversations. The roles and the interests of a user may be integrated with a social profile and communication data to weigh the summaries. For example, the online collaboration checkpoint program 110A, 110B may pull data related to a user interest from social media sites, emails or any chat applications. A job role listed in the profile of a user may start with a generic description. For instance, a content designer may have basic responsibilities of writing documentation and reviewing text within an interface. The user may then update the description with other tasks and responsibilities as needed. Information related to a user's job role may be pulled from internal company descriptions and a basic search of a job role to compile related keywords. In another example, a job role may be maintained as an ontology or dictionary that may pinpoint terms to prioritize information involved in a conversation or may be identified using unsupervised learning system to cluster groups of users. The same job role association may be assigned based on a job title pulled from the footer of an email or may be updated and refined by a user to encompass all of their responsibilities and tasks. The online collaboration checkpoint program 110A, 110B may also use real-time profile data from emails or project work to further personalize the job role toward the profile and may also utilize any online professional profile sites to gain further insight into how much knowledge a user may have on certain topics. The online collaboration checkpoint program 110A, 110B may allow a user to manually re-weight or revise the user interest on a particular topic, and such interests may be prepopulated in later uses. The online collaboration checkpoint program 110A, 110B may then associate each summary with each identified role to personalize the summary.

At 208, the online collaboration checkpoint program 110A, 110B generates a personalized summary of the missed content based on the user's role or interests in the current in-focus conversation. According to one embodiment, the online collaboration checkpoint program 110A, 110B may send a user a summary of what the possible summaries each participant has seen in the current conversation channel. The online collaboration checkpoint program 110A, 110B may present summaries showing how well each role or each participant understands or would find interesting certain elements in missed conversations. For example, a user whose job responsibility is to manage a project team may receive and review the summaries presented to other team members that have been associated with each team member's interest and job role, so that the user may better understand where the team members were at and what messages were communicated while the user was out of the conversation channel to gauge how and when to re-engage the channel as a manager. In at least one other embodiment, the online collaboration checkpoint program 110A, 110B may form a ring when identifying summaries which are based on similar perspectives, such that a user may more quickly flow through missed meetings. In yet another embodiment, the online collaboration checkpoint program 110A, 110B may present a user with a summary that contains remediation steps if summary presents a negative or positive sentiment. For example, if a summary indicates that a second-line manager was excited about a proposed countermeasure for a product defect, the summary may suggest a prepopulated language, such as “post positive feedback or statement”. If a summary indicates that managers were negative about certain comments made by a certain team member, the summary may indicate “explain the team member's current job role and progress to your manager”.

It may be appreciated that FIG. 2 provides only an illustration of one implementation and does not imply any limitations with regard to how different embodiments may be implemented. Many modifications to the depicted environments may be made based on design and implementation requirements. For example, in at least one embodiment, the online collaboration checkpoint program 110A, 110B may process summaries of missed content only at a specific point of time, limit the number of summaries based on importance specific to a user's job role or interest or limit chronologically the number of summaries.

FIG. 3 is a block diagram of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smartphone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the online collaboration checkpoint program 110A in the client computing device 102 and the online collaboration checkpoint program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes an R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the online collaboration checkpoint program 110A, 110B can be stored on one or more of the respective portable computer-readable tangible storage devices 338, read via the respective R/W drive or interface 332 and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the online collaboration checkpoint program 110A in the client computing device 102 and the online collaboration checkpoint program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the online collaboration checkpoint program 110A in the client computing device 102 and the online collaboration checkpoint program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

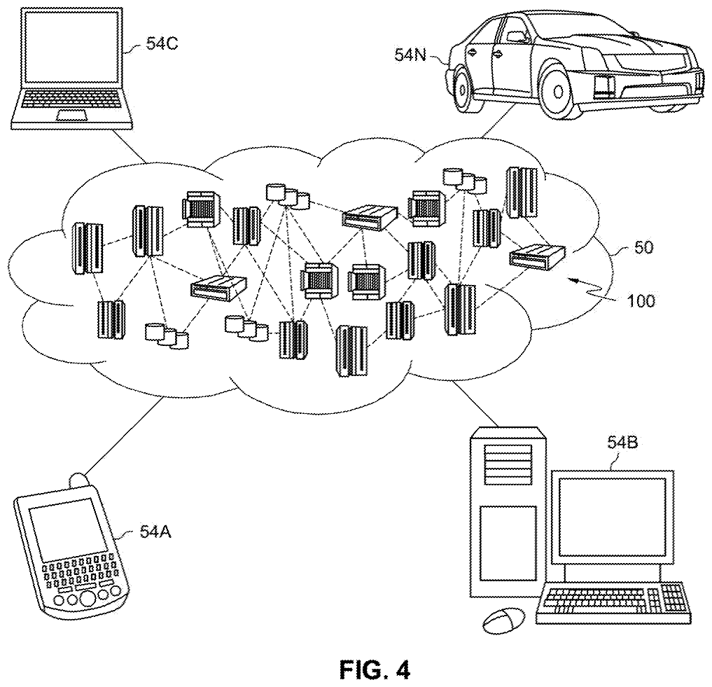

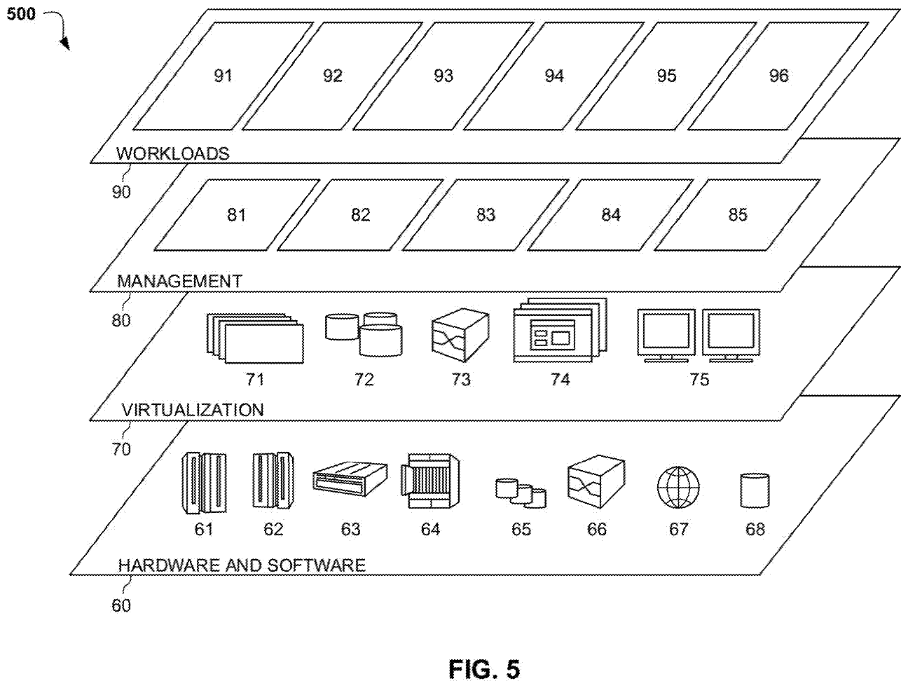

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and online collaboration checkpoint 96. Online collaboration checkpoint 96 may relate to generating a personalized summary of missed content from multiple collaboration platforms.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for generating a personalized summary of missed content from across multiple collaboration platforms, the method comprising:
monitoring user participation with respect to a plurality of conversations across a plurality of collaboration platforms;
determining content the user missed from the plurality of conversations based on the user participation;
summarizing the missed content from each of the plurality of collaboration platforms; and
presenting the summarized missed content to the user in a current conversation.

2. The method of claim 1, wherein monitoring the user participation comprises monitoring when a conversation within the plurality of conversations starts, a user joins the conversation, monitoring the user participation, and monitoring when the user leaves the conversation.

3. The method of claim 1, wherein summarizing the missed content is based on a user attribute which is selected from a group consisting of user job role, interests, and responsibilities.

4. The method of claim 1, further comprising:
generating summaries of other participants of a conversation within the plurality of conversations to indicate how other participants are understanding the conversation within the plurality of conversations, following the conversation, and highlighting divergence in the summarized content.

5. The method of claim 1, further comprising:
associating the summaries based social profile data and communication data received from social media sites.

6. The method of claim 1, further comprising:
limiting a number of summaries presented to the user based on a determination that the summaries exceed a preconfigured importance threshold or a specific point of time.

7. The method of claim 1, further comprising:
allowing the user to manually update or revise a job role or responsibilities.

8. A computer system for generating a personalized summary of missed content from across multiple collaboration platforms, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
monitoring user participation with respect to a plurality of conversations across a plurality of collaboration platforms;
determining content the user missed from the plurality of conversations based on the user participation;
summarizing the missed content from each of the plurality of collaboration platforms; and
presenting the summarized missed content to the user in a current conversation.

9. The computer system of claim 8, wherein monitoring the user participation comprises monitoring when a conversation within the plurality of conversations starts, a user joins the conversation, monitoring the user participation, and monitoring when the user leaves the conversation.

10. The computer system of claim 8, wherein summarizing the missed content is based on a user attribute which is selected from a group consisting of user job role, interests, and responsibilities.

11. The computer system of claim 8, further comprising:
generating summaries of other participants of a conversation within the plurality of conversations to indicate how other participants are understanding the conversation within the plurality of conversations, following the conversation, and highlighting divergence in the summarized content.

12. The computer system of claim 8, further comprising:
associating the summaries based social profile data and communication data received from social media sites.

13. The computer system of claim 8, further comprising:
limiting a number of summaries presented to the user based on a determination that the summaries exceed a preconfigured importance threshold or a specific point of time.

14. The computer system of claim 8, further comprising:
allowing the user to manually update or revise a job role or responsibilities.

15. A computer program product for generating a personalized summary of missed content from across multiple collaboration platforms, the computer system comprising:
one or more computer-readable tangible storage media and program instructions stored on at least one of the one or more tangible storage media, the program instructions executable by a processor of a computer to perform a method, the method comprising:
monitoring user participation with respect to a plurality of conversations across a plurality of collaboration platforms;
determining content the user missed from the plurality of conversations based on the user participation;
summarizing the missed content from each of the plurality of collaboration platforms; and
presenting the summarized missed content to the user in a current conversation.

16. The computer program product of claim 15, wherein monitoring the user participation comprises monitoring when a conversation within the plurality of conversations starts, a user joins the conversation, monitoring the user participation, and monitoring when the user leaves the conversation.

17. The computer program product of claim 15, wherein summarizing the missed content is based on a user attribute which is selected from a group consisting of user job role, interests, and responsibilities.

18. The computer program product of claim 15, further comprising:
generating summaries of other participants of a conversation within the plurality of conversations to indicate how other participants are understanding the conversation within the plurality of conversations, following the conversation, and highlighting divergence in the summarized content.

19. The computer program product of claim 15, further comprising:
associating the summaries based social profile data and communication data received from social media sites.

20. The computer program product of claim 15, further comprising:
limiting a number of summaries presented to the user based on a determination that the summaries exceed a preconfigured importance threshold or a specific point of time.
